(19) United States
(12) Patent Application Publication
(10) Pub. No.: US 2026/0167231 A1
(43) Pub. Date: Jun. 18, 2026

(54) METHOD AND APPARATUS FOR ESTIMATING A YAW RATE AND PREDICTING A PATH OF A TARGET

(71) Applicants: HYUNDAI MOTOR COMPANY, Seoul (KR); KIA CORPORATION, Seoul (KR)

(72) Inventors: Sung Wook Lee, Hwaseong-si (KR); Na Hyun Kweon, Hwaseong-si (KR)

(73) Assignees: HYUNDAI MOTOR COMPANY, Seoul (KR); KIA CORPORATION, Seoul (KR)

(21) Appl. No.: 19/336,459

(22) Filed: Sep. 22, 2025

(30) Foreign Application Priority Data
Dec. 18, 2024 (KR) 10-2024-0190123

(51) Int. Cl. B60W 60/00; B60W 40/04; B60W 50/00

(52) U.S. Cl. CPC B60W 60/0027; B60W 40/04; B60W 2050/0056; B60W 50/0098; B60W 2554/4042; B60W 2554/4044; B60W 2556/10

(57) ABSTRACT

A method for predicting a driving path of a target includes receiving driving information of an ego vehicle and the target from a plurality of sensors attached to the ego vehicle. The method further includes calculating a heading angle and driving direction of the target based on bounding box of the target. The heading angle of the target is a heading angle of the bounding box of the target. The method further includes calculating a yaw rate of the target based on the heading angle and the driving direction of the target. The method further includes generating a yaw rate profile of the target based on the yaw rate of the target. The method further includes predicting a path of the target based on the yaw rate profile of the target.

### CROSS-REFERENCE TO RELATED APPLICATION

The present application claims the benefit of and priority to Korean Patent Application No. 10-2024-0190123, filed on Dec. 18, 2024, the entire contents of which are incorporated herein by reference.

### TECHNICAL FIELD

The present disclosure relates to a method and an apparatus for estimating a yaw rate and predicting a path of a target. More particularly, the present disclosure relates to a method and an apparatus capable of improving path prediction accuracy by calculating the yaw rate of a target using multiple different yaw rate estimation methods and predicting the path of the target based on the calculated yaw rate.

### BACKGROUND

The matters described in this Background section are only for enhancement of understanding of the background of the disclosure and should not be taken as acknowledgement that they correspond to prior art already known to those having ordinary skill in the art.

An autonomous vehicle needs to predict the future path of an object (target) around the autonomous vehicle for path planning and a collision avoidance decision. For example, when there is an object such as other vehicles, pedestrians, and personal mobility devices around the autonomous vehicle, the autonomous vehicle should predict the future path of the target and should warn a driver or take evasive action before a collision occurs.

The related art utilizes the target's driving information (speed, direction, position, etc.) and map information or lane information to predict the driving path of a target vehicle driving on a road. Because the target driving on the road generally drives along a lane, the related art predicts the target's driving path based on map information or lane information of an area in which an ego vehicle and the target are driving.

The related art has limitations in that it is difficult to accurately predict the target's driving path when the map information or the lane information may not be utilized. In order to accurately predict the target's driving path, information on the yaw rate of the target is required, but the yaw rate value of the target may not be directly recognized using a sensor attached to the vehicle.

Assuming that the yaw rate value of the target is 0, the yaw rate of the target may be ignored and the path may be predicted. However, assuming that the target is driving straight in a current driving direction in a situation where the target is turning (such as on a curved road or at an intersection), a predicted path will deviate significantly from an actual future path of the target.

Among conventional technologies, there is a technology for estimating the yaw rate of the target based on the amount of change in the heading angle of the target. However, this is problematic in that the error of the target's heading angle caused by sensor recognition error is large, leading to significant distortion in the yaw rate of the target.

### SUMMARY

The present disclosure provides a method and an apparatus capable of more accurately calculating the yaw rate of a target, by using multiple different yaw rate estimation methods.

The present disclosure provides a method and an apparatus capable of more accurately predicting the driving path of a target, based on the yaw rate profile of the target.

Technical objects to be achieved by the present disclosure are not limited to those described above, and other technical objects not mentioned above may also be clearly understood from the present disclosure by those having ordinary skill in the art to which the present disclosure belongs.

An embodiment of the present disclosure provides a method for predicting a driving path of a target. The method includes receiving driving information of an ego vehicle and the target from a plurality of sensors attached to the ego vehicle. The method further includes calculating a heading angle and driving direction of the target based on bounding box of the target. The heading angle of the target is a heading angle of the bounding box of the target. The method further includes calculating a yaw rate of the target based on the heading angle and the driving direction of the target. The method further includes generating a yaw rate profile of the target based on the yaw rate of the target; and predicting a path of the target based on the yaw rate profile of the target.

Another embodiment of the present disclosure provides an apparatus for predicting a driving path of a target. The apparatus includes at least one memory configured to store commands; and at least one processor. The at least one processor is configured, by executing the commands to receive driving information of an ego vehicle and the target from a plurality of sensors attached to the ego vehicle. The at least one processor is further configured to calculate a heading angle and driving direction of the target based on bounding box of the target. The heading angle of the target is a heading angle of the bounding box of the target. The at least one processor is further configured to calculate a yaw rate of the target based on the heading angle and the driving direction of the target. The at least one processor is further configured to generate a yaw rate profile of the target based on the yaw rate of the target. The at least one processor is further configured to predict a path of the target based on the yaw rate profile of the target.

According to an embodiment of the present disclosure, it is possible to generate a more accurate yaw rate profile by calculating the yaw rate of a target using multiple different yaw rate estimation methods.

According to an embodiment of the present disclosure, it is possible to improve path prediction accuracy for a target based on the yaw rate profile of the target.

According to an embodiment of the present disclosure, it is possible to improve path prediction accuracy for a target by correcting the initial heading angle of the target based on the yaw rate of the target, in a situation where the target is driving in relation to a lane.

The advantageous effects of the present disclosure are not limited to those described above; other advantageous effects of the present disclosure not mentioned above may be understood clearly by those having ordinary skill in the art from the descriptions given below.

### BRIEF DESCRIPTION OF THE DRAWINGS

FIG. 1 is a block diagram schematically showing a path generating device according to an embodiment of the present disclosure.

FIG. 2 is a flowchart schematically illustrating a process in which the path generating device according to an embodiment of the present disclosure generates a predicted path of a target.

FIG. 3 is a diagram illustrating an example of a bounding box of the target to explain a method of calculating a heading angle of the target according to an embodiment of the present disclosure.

FIG. 4 is a diagram illustrating an example of the position coordinate and speed vector of the target to explain a method of calculating a driving direction of the target according to an embodiment of the present disclosure.

FIG. 5 is a diagram showing a difference between a heading angle θ_{B} of the target and a driving direction θᵥ of the target, which occurs when the target turns to the right.

FIG. 6 and and FIG. 7 each are a diagram showing an example of a yaw rate profile of the target.

FIG. 8 is a flowchart illustrating a process by which a path generating device performs kinematics-based path prediction for the target based on the yaw rate profile, speed profile, and current position of the target according to an embodiment of the present disclosure.

FIG. 9 is a graph comparing yaw rate values of the target for each time calculated through various methods with yaw rate values of the target for each actual time.

FIG. 10 is a graph comparing predicted paths of the target calculated through various methods with an actual driving path of the target.

FIG. 11 is a block diagram schematically illustrating a computing device that may be used to implement a method or apparatus according to the present disclosure.

### DETAILED DESCRIPTION

Hereinafter, some embodiments of the present disclosure are described in detail with reference to the accompanying drawings. In the present disclosure, like reference numerals designate like elements, although the elements are shown in different drawings. Further, in the present disclosure, a detailed description of known functions and configurations incorporated therein has been omitted for the purpose of clarity and for brevity.

Additionally, various terms, such as first, second, A, B, (a), (b), etc., are used solely to differentiate one component from the other but are not intended to imply or suggest the substances, order, or sequence of the components. Throughout the present disclosure, when a part ‘includes’ or ‘comprises’ a component, the part is meant to further include other components is not intended to exclude thereof unless specifically stated to the contrary. The terms, such as ‘unit’, ‘module’, and the like, refer to one or more units for processing at least one function or operation, which may be implemented by hardware, software, or a combination thereof. When a controller, unit, module, component, device, element, or the like of the present disclosure is described as having a purpose or performing an operation, function, or the like, the controller, unit, module, component, device, element, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus.

The following detailed description, together with the accompanying drawings, is intended to describe embodiments of the present disclosure and is not intended to represent the only embodiments in which the present disclosure may be practiced.

In the present disclosure, path prediction refers to the function of an autonomous driving system to predict the future path of a target (an object existing around an ego vehicle).

In the present disclosure, a prediction time window refers to a time window from a current time, at which the autonomous driving system attempts to predict the path, to a future time. The length of the prediction time window may be expressed in the unit of time. For example, if the autonomous driving system predicts a path from a current time to a future time 4 seconds later, the length of the prediction time window is 4 seconds.

In the present disclosure, a prediction time interval refers to a time interval during which the autonomous driving system predicts a path. The prediction time interval may be expressed in the unit of time. For example, if the autonomous driving system predicts the path in 0.1-second intervals, the prediction time interval is 0.1 seconds.

In the present disclosure, an ego coordinate is a Cartesian coordinate in which the origin is located at the front of the ego vehicle, the x-axis is parallel to the driving direction of the ego vehicle, and the y-axis is perpendicular to the driving direction of the ego vehicle.

In the present disclosure, a ground coordinate is a Cartesian coordinate in which the origin is located on the ground, the x-axis and y-axis are parallel to the ground, and the z-axis is perpendicular to the ground.

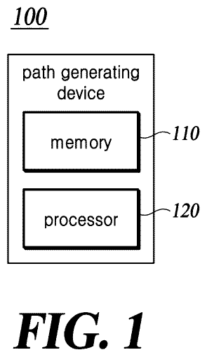

FIG. 1 is a block diagram schematically showing a path generating device according to an embodiment of the present disclosure.

The path generating device 100 includes a memory 110 and a processor 120. The path generating device 100 may be implemented in the form of an embedded device, a server, an electronic device within an autonomous driving system, etc. Not all blocks illustrated in FIG. 1 are essential components, and some blocks included in the path generating device 100 may be added, changed, or deleted in other embodiments. Meanwhile, the components illustrated in FIG. 1 represent functionally distinct elements, and one or more components may be implemented to be integrated with each other in an actual physical environment.

The memory 110 stores data and commands required for the operation of the path generating device 100.

The memory 110 may store driving information of the ego vehicle acquired using at least one sensor included in the ego vehicle. The driving information of the ego vehicle may include the velocity, acceleration, heading angle, yaw rate, etc. of the ego vehicle.

Further, the memory 110 may store driving information of the target acquired using at least one sensor included in the ego vehicle. The driving information of the target may include the position, velocity, etc. of the target. In particular, each of the position and velocity of the target may be a relative position and a relative velocity with respect to the ego vehicle.

Further, the driving information of the target may be expressed by the position and speed of a bounding box that surrounds the target. For example, the bounding box is a shape identical or similar to a rectangular parallelepiped, and the position of the target may be expressed by eight coordinates corresponding to the vertices of the bounding box, and the speed of the target may be expressed by the speed of the center point of the bounding box.

The processor 120 controls the overall operation of the path generating device 100. The processor 120 may be implemented with one or more processors. The processor 120 may execute commands stored in the memory 110.

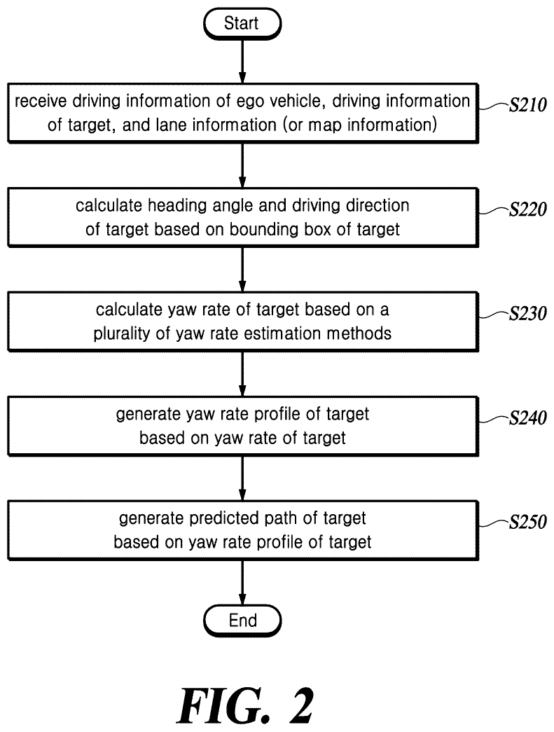

FIG. 2 is a flowchart schematically illustrating a process in which the path generating device 100 according to an embodiment of the present disclosure generates the predicted path of the target.

The path generating device 100 receives driving information of the ego vehicle, driving information of the target, and lane information (or map information) from a plurality of sensors attached to the ego vehicle, in step S210.

The path generating device 100 calculates the heading angle and driving direction of the target based on the bounding box information of the target, in step S220. The path generating device 100 calculates the yaw rate of the target based on the heading angle and driving direction of the target using multiple yaw rate estimation methods in step S230. The path generating device 100 generates the yaw rate profile of the target based on the yaw rate of the target in step S240. Finally, the path generating device 100 generates the predicted path of the target based on the yaw rate profile of the target, in step S250.

Hereinafter, steps S220 to S250 are described in detail.

The path generating device 100 calculates the heading angle of the target and the driving direction of the target based on the bounding box information of the target in step S220. Here, the heading angle of the target is an angle at which the front of the target faces, and the heading angle of the target refers to the heading angle of the bounding box.

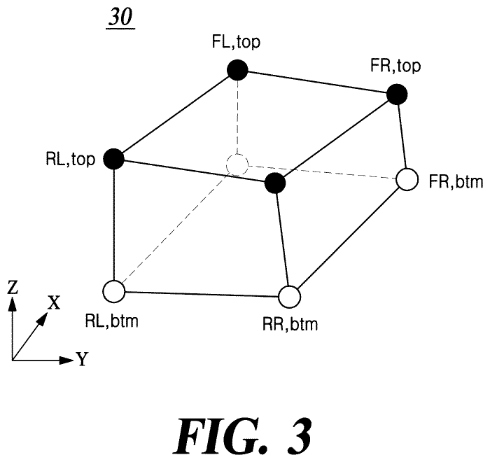

FIG. 3 is a diagram illustrating an example of the bounding box of the target to explain a method of calculating the heading angle of the target, i.e., the heading angle of the bounding box surrounding the target according to an embodiment of the present disclosure. The bounding box of the target may be expressed as eight coordinate values corresponding to the vertices of the bounding box. In an embodiment, eight coordinate values corresponding to the vertices of the bounding box may be coordinate values based on the ground coordinate.

In FIG. 3, eight points represent the vertices of the bounding box 30 of the target, black points define the top surface of the bounding box 30, and white points define the bottom surface of the bounding box 30. In FIG. 3, FL represents the front left of the target 20, FR represents the front right of the target 20, RL represents the rear left of the target 20, and RR represents the rear right of the target 20.

The path generating device 100 may calculate the heading angle of the top surface of the bounding box 30, the heading angle of the bottom surface thereof, and the average of the heading angles of the top and bottom surfaces thereof to calculate the heading angle of the bounding box. Equation 1 is an equation that calculates the heading angle of the top surface of the bounding box 30 and the heading angle of the bottom surface thereof, while Equation 2 is an equation that calculates the average of the heading angles of the top and bottom surfaces of the bounding box 30.

$$\{ \begin{matrix}{θ}_{B , top} = {tan}^{- 1} ( \frac{\frac{{Y}_{FL , top} + {Y}_{FR , top}}{2} - \frac{{Y}_{RL , top} + {Y}_{RR , top}}{2}}{\frac{{X}_{FL , top} + {X}_{FR , top}}{2} - \frac{{X}_{RL , top} + {X}_{RR , top}}{2}} ) \\ {θ}_{B , btm} = {tan}^{- 1} ( \frac{\frac{{Y}_{FL , btm} + {Y}_{FR , btm}}{2} - \frac{{Y}_{RL , btm} + {Y}_{RR , btm}}{2}}{\frac{{X}_{FL , btm} + {X}_{FR , btm}}{2} - \frac{{X}_{RL , btm} + {X}_{RR , btm}}{2}} )\end{matrix} \qquad [ Equation 1 ]$$

$${θ}_{B} = \frac{{θ}_{B , top} + {θ}_{B , btm}}{2} \qquad [ Equation 2 ]$$

In Equation 1 and Equation 2, θ_{B,top} and θ_{B,btm} represent the heading angle of the top surface of the bounding box 30 and the heading angle of the bottom surface thereof, respectively, θ_{B} represents the average of the heading angles, and (X_{FL,top}, Y_{FL,top}) represents the coordinate value of the vertices of the bounding box 30 based on the ego coordinate.

The path generating device 100 may set the average θ_{B} of the heading angles of the top and bottom surfaces of the bounding box calculated using Equation 1 and Equation 2 as the heading angle of the bounding box 30.

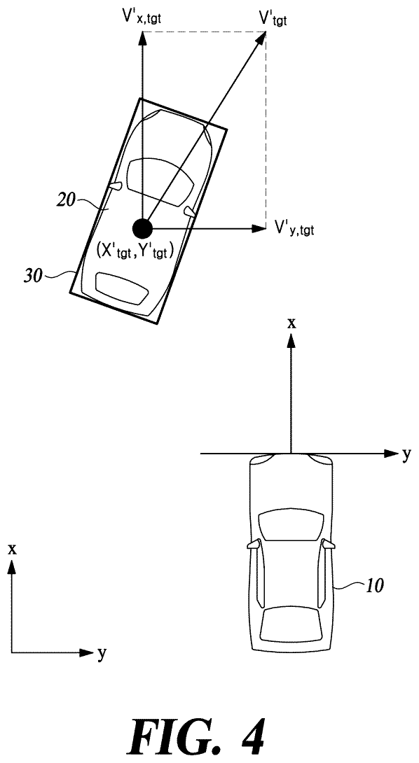

FIG. 4 is a diagram illustrating an example of the position coordinate and speed vector of the target to explain a method of calculating the driving direction of the target according to an embodiment of the present disclosure. In an embodiment, the driving direction of the target may mean the angle of vector representing the ground speed of the target. Here, the term “ground speed” refers to the speed of the target relative to the ground.

Referring to FIG. 4, the coordinate axes of the ego coordinate are depicted on the front of the ego vehicle 10, and the coordinate axes of the ground coordinate are depicted on the left bottom. In FIG. 4, (X′_{tgt}, Y′_{tgt}) represents the position of the target 20 in the ego coordinate, and V′_{tgt} represents the speed vector of the target 20 in the ego coordinate. In an embodiment, the position of the target 20 may correspond to the center position of the bounding box 30, and the speed of the target 20 may correspond to the center speed of the bounding box 30.

Equation 3 is an equation for calculating the ground speed of the target 20, and Equation 4 is an equation for calculating the driving direction of the target 20 from the ground speed of the target 20.

$$\{ \begin{matrix}{V}_{x , tgt} = {V}_{x , tgt}^{′} + {V}_{e g o} - {Y}_{tgt}^{′} \cdot {γ}_{ego} \\ {V}_{y , tgt} = {V}_{y , tgt}^{′} + {X}_{tgt}^{′} \cdot {γ}_{ego}\end{matrix} \qquad [ Equation 3 ]$$

$${θ}_{V} = {tan}^{- 1} ( \frac{{V}_{y , tgt}}{{V}_{x , tgt}} ) \qquad [ Equation 4 ]$$

In Equation 3 and Equation 4, V_{x,tgt} and V_{y,tgt} represent the x-axis and y-axis components of the ground speed of the target 20, respectively. In Equation 3, V′_{x,tgt} and V′_{y,tgt} represent the x-axis and y-axis components of the speed of the target 20 in the ego coordinate, X′_{tgt} and Y′_{tgt} represent the x-axis and y-axis components of the position of the target 20 in the ego coordinate, respectively, V_{ego} represents the ground velocity of the ego vehicle 10, and γ_{ego} represents the yaw rate of the ego vehicle 10.

The path generating device 100 calculates the yaw rate of the target 20 based on the heading angle of the bounding box 30 and the driving direction of the target 20, in step S230. Here, the yaw rate of the target 20 may mean a yaw rate based on the ground coordinate, i.e., a ground yaw rate.

The path generating device 100 uses multiple different yaw rate estimation methods so as to calculate the yaw rate of the target 20.

A first method is to calculate the yaw rate of the target 20 based on the amount of change in the heading angle of the bounding box 30.

The yaw rate of the target 20 may be calculated based on a difference between the heading angle of the bounding box 30 at current time and the heading angle of the bounding box 30 at previous time. Equation 5 is an equation for calculating the yaw rate of the target 20 according to the first method.

$${γ}_{B} = \frac{{\{ {θ}_{B} \}}_{t} - {\{ {θ}_{B} \}}_{t - 1}}{Δ t} + {γ}_{ego} \qquad [ Equation 5 ]$$

In Equation 5, γ_{B} represents the yaw rate value of the target 20 calculated using the first method, {θ_{B}}ₜ represents the heading angle of the bounding box 30 calculated at time t, and Δt is a sampling period, which means a time interval for performing sampling. γ_{ego} represents the raw rate of an ego vehicle 10.

In an additional embodiment, the path generating device 100 may determine that the yaw rate γ_{B} of the target 20 is valid only when a tracking age for the target 20 is a predetermined time or longer. Here, the tracking age refers to time when a sensor maintains recognition for the target. This is because the target 20 should be sufficiently observed to compare the driving direction of the target 20 at different times.

In an additional embodiment, the path generating device 100 may determine that the yaw rate γ_{B} of the target 20 is valid only when the change amount {θ_{B}}ₜ−{θ_{B}}ₜ₋₁ of the heading angle of the bounding box 30 is equal to or less than a predetermined value. This is because the yaw rate value may diverge, making it inappropriate for use as a yaw rate value, when a difference between the heading angle of the bounding box 30 at the current time and the heading angle of the bounding box 30 at the previous time is too large.

Further, in an additional embodiment, a noise removal filter may be used to minimize the influence of noise included in the change amount of the heading angle of the bounding box 30. For example, the path generating device 100 may perform low-pass filtering or moving average filtering on the heading-angle change amount {θ_{B}}ₜ−{θ_{B}}ₜ₋₁.

A second method is to calculate the yaw rate of the target 20 based on the amount of change in the driving direction of the target 20.

The yaw rate of the target 20 may be calculated based on a difference between the driving direction of the target 20 at current time and the driving direction of the target 20 at previous time. Equation 6 is an equation for calculating the yaw rate of the target 20 according to the second method.

$${γ}_{V} = \frac{{\{ {θ}_{V} \}}_{t} - {\{ {θ}_{V} \}}_{t - 1}}{Δ t} + {γ}_{ego} \qquad [ Equation 6 ]$$

In Equation 6, γᵥ represents the calculated yaw rate value of the target 20 using the second method, {θᵥ}ₜ represents the driving direction of the target 20 calculated at time t, and Δt is the sampling period, which means a time interval for performing sampling. γ_{ego} represents the raw rate of the ego vehicle 10.

In an additional embodiment, the path generating device 100 may determine that the yaw rate γᵥ of the target 20 is valid only when the tracking age for the target 20 is a predetermined time or longer. This is because the target 20 should be sufficiently observed to compare the driving direction of the target 20 at different times.

In an additional embodiment, the path generating device 100 may determine that the yaw rate γᵥ of the target 20 is valid only when the change amount {θᵥ}-{θᵥ}ₜ₋₁ of the driving direction of the target 20 is equal to or less than a predetermined value. This is because the yaw rate value may diverge, making it inappropriate for use as a yaw rate value, when a difference between the driving direction of the target 20 at the current time and the driving direction of the target 20 at the previous time is too large.

Further, in an additional embodiment, a noise removal filter may be used to minimize the influence of noise included in the change amount {θᵥ}ₜ-{θᵥ}ₜ₋₁ of the driving direction of the target 20. For example, the path generating device 100 may perform low-pass filtering or moving average filtering on the driving-direction change amount {θ_{B}}ₜ-{θ_{B}}ₜ₋₁.

A third method is to calculate the yaw rate of the target 20 based on a difference between the heading angle of the bounding box 30 and the driving direction of the target 20.

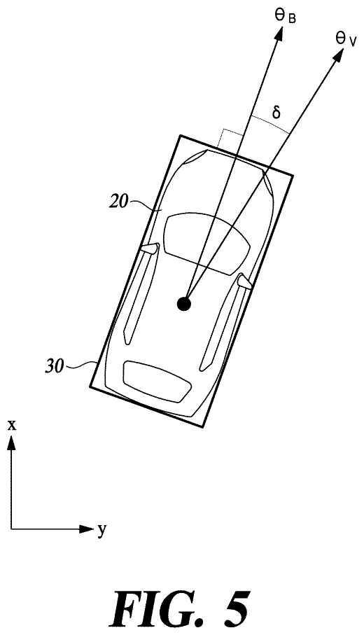

When a vehicle turns, a difference occurs between the heading angle of the bounding box and the driving direction of the vehicle, and the difference becomes larger as the vehicle travels at a higher curvature. FIG. 5 is a diagram showing a difference between the heading angle θ_{B} of the bounding box 30 and the driving direction θᵥ of the target 20, which occurs when the target 20 turns to the right. In FIG. 5, two arrows represent the heading angle θ_{B} of the bounding box 30 and the driving direction θᵥ of the target 20, and δ represents an angular difference between the heading angle θ_{B} and the driving direction θᵥ.

If the difference between the heading angle θ_{B} of the bounding box 30 and the driving direction θᵥ of the target 20 is considered as the turning angle of the target, the yaw rate of the target 20 may be estimated. Equation 7 is an equation for calculating the yaw rate of the target 20 according to the third method.

$$\begin{matrix}{γ}_{G} = {κ}_{tgt} \cdot \vert {V}_{tgt , i} \vert \\ = \frac{tan δ}{{L}_{tgt}} \cdot \vert {V}_{tgt , i} \vert \\ = \frac{tan ( {\{ {θ}_{V} \}}_{t} - {\{ {θ}_{B} \}}_{t} )}{{L}_{tgt}} \cdot \vert {V}_{tgt , i} \vert\end{matrix} \qquad [ Equation 7 ]$$

In Equation 7, γ_{G} represents the yaw rate value of the target 20 calculated using the third method, κ_{tgt} represents the curvature of the target 20, δ represents a difference between the heading angle θ_{B} of the bounding box 30 and the driving direction θᵥ of the target 20, and L_{tgt} represents a distance between the ego vehicle 10 and the target 20. |V_{tgt,i}| represents speed at i-th time included in the speed profile of the target 20. In the present disclosure, it is assumed that the speed profile of the target 20 reflecting the acceleration and deceleration of the target 20 has been already generated.

In an additional embodiment, in order to secure robustness against the difference between the heading angle θ_{B} of the bounding box 30 and the driving direction θᵥ, the heading angle of the bounding box 30 prior to a predetermined time may be used instead of the heading angle of the bounding box 30 at the current time. In other words, a time-delayed value may be used for the heading angle of the bounding box 30. For example, the heading angle of the bounding box 30 may be the heading angle 0.1 seconds ago. Equation 8 is an equation for calculating a difference δ between the driving direction of the target at the current time and the heading angle of the time-delayed bounding box 30.

$$δ = {\{ {θ}_{V} \}}_{0 , 0} - {\{ {θ}_{B} \}}_{- T , 0} where \qquad [ Equation 8 ]$$

$${\{ {θ}_{B} \}}_{t 1 , t 2} = {\{ {θ}_{B} \}}_{t 1} - {\int }_{t 1}^{t 2} {γ}_{ego} d t$$

In Equation 8, {θ_{B}}_{t1,t2} is the heading angle of the target at time t1 observed at time t1, expressed based on time t2. For example, {θ_{B}}_{0,0} represents the heading angle of the target at the current time, which is observed at the current time, and {θ_{B}}_{-T,0} represents a past heading angle of the target T seconds ago based on the direction of the ego vehicle at the current time. Because the ego vehicle may rotate during time elapsed from time t1 to time t2, correction is required by the rotating amount of the ego vehicle when calculating the direction of the target at time t1 based on the direction of the ego vehicle at time t2.

In an additional embodiment, the path generating device 100 may determine that the yaw rate γᵥ of the target 20 is valid only when the tracking age for the target 20 is a predetermined time or longer. This is because the target 20 should be sufficiently observed to compare the driving direction of the target 20 at different times.

In an additional embodiment, the path generating device 100 may determine that the yaw rate γ_{G} of the target 20 is valid only when the difference δ between the heading angle θ_{B} of the target 20 and the driving direction θᵥ is equal to or less than a predetermined value. This is because the yaw rate value may diverge, making it inappropriate for use as a yaw rate value, when a difference between the driving direction of the target 20 at the current time and the driving direction of the target 20 at the previous time is too large.

Further, in an additional embodiment, a noise removal filter may be used to minimize the influence of noise included in the difference δ between the heading angle θ_{B} of the target 20 and the driving direction θᵥ. For example, the path generating device 100 may perform low-pass filtering or moving average filtering on the difference δ between the heading angle θ_{B} and the driving direction θᵥ.

The first and second methods have excellent yaw rate estimation response, making it more accurate than the third method in a situation where the target is turning at high speed. However, since the methods calculate the yaw rate based on the amount in change of each of the heading angle θ_{B} and the driving direction θᵥ, they have the drawback of being sensitive to noise. The third method is more accurate than the first and second methods when the target is turning at low speed, and the third method is insensitive to noise because it calculates the yaw rate based on the difference between the heading angle θ_{B} and the driving direction θᵥ. However, it has the drawback in that the yaw rate estimation response is slow and both the heading angle θ_{B} and the driving direction θᵥ should be valid.

The path generating device 100 according to the present disclosure can compensate for the drawback of each estimation method by using multiple different yaw rate estimation methods.

The path generating device 100 may select an optimal yaw rate value among the yaw rate values of the target 20 calculated according to the first method, the second method, and the third method. Equation 9 is an equation for determining the yaw rate γ_{tgt} of the target 20 in an embodiment.

$${γ}_{tgt} = sign ( {γ}_{G} ) \cdot min ( \vert {γ}_{B} \vert , \vert {γ}_{V} \vert , \vert {γ}_{G} \vert ) \qquad [ Equation 9 ]$$

In Equation 9, sign(·) is a signum function, and min (|γ_{B}|, |γᵥ|, |γ_{G}|) represents a minimum value among the yaw rate values of the target 20 calculated according to the first method, the second method, and the third method.

In an embodiment, the path generating device 100 may determine that the yaw rate γ_{tgt} of the target 20 is valid only when the signs of γ_{B}, γᵥ and γ_{G} are all the same. This is to minimize side effects that may occur when the signs of the yaw rate values for each method are different.

In an additional embodiment, the path generating device 100 may determine that the yaw rate γ_{tgt} of the target 20 is valid only when the target 20 is a target recognized by a plurality of different sensors attached to the vehicle 10. For example, the path generating device 100 may determine whether the target 20 has been recognized by each of a camera and lidar sensors. This is to minimize the error in the yaw rate value by minimizing the error in the heading angle θ_{B} of the bounding box and/or the driving direction θᵥ of the target due to the recognition error of the sensor.

In an additional embodiment, the path generating device 100 may determine that the yaw rate γ_{tgt} of the target 20 is valid only when the target 20 is driven at a preset value or more. This is because, when the target 20 is driving at very low speed, the recognition error of the sensor for the speed of the target 20 is large, so the driving direction θᵥ of the target 20 is unreliable.

In an additional embodiment, the path generating device 100 may determine that the yaw rate γ_{tgt} of the target 20 is valid only when the relative speed of the target 20 is equal to or less than a preset value. This is because, when the target 20 is driving at relatively very high speed, the sensor's recognition error with respect to the driving direction θᵥ of the target 20 may be large.

In an additional embodiment, the path generating device 100 may determine that the yaw rate γ_{tgt} of the target 20 is valid only when a difference between the heading angle θ_{B} of the target 20 and the driving direction θᵥ falls within a preset range. This is because, when the difference between the heading angle θ_{B} of the target 20 and the driving direction θᵥ is large, it can be seen that the target 20 is moving backwards or that the sensor attached to the ego vehicle 10 is in an abnormal recognition state.

The path generating device 100 generates the yaw rate profile of the target 20 based on the yaw rate γ_{tgt} of the target 20 calculated in step S230, in step S240. Here, the yaw rate profile means a sequence of yaw rate values representing yaw rate values at each time within a prediction time window. For example, if the prediction time window is 4 seconds and the time interval is 0.1 seconds, the yaw rate profile contains 41 (=4s/0.1s+1) yaw rate values predicted at 0.1 second intervals.

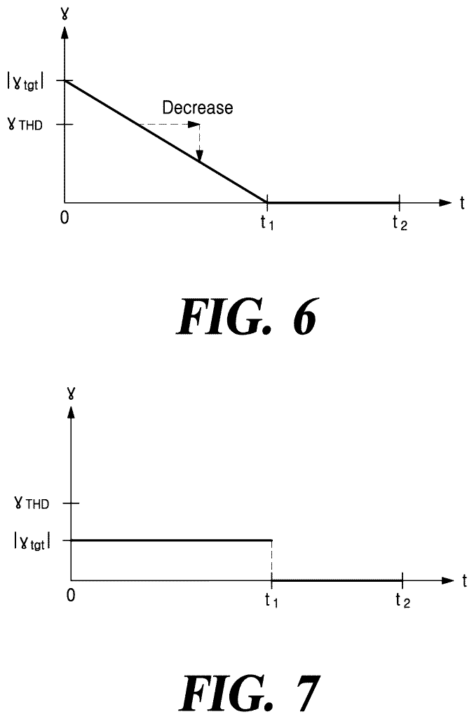

FIG. 6 and FIG. 7 each are a diagram showing an example of the yaw rate profile of the target 20. In FIG. 6 and FIG. 7, a horizontal axis represents time, and a vertical axis represents the magnitude of the yaw rate. Further, the yaw rate γ_{tgt} of the target 20 calculated in step S230 represents the yaw rate γ_{tgt,0} of the target 20 at the current time. The path generating device 100 generates the yaw rate profile of the target 20 during the prediction time window (0≤t≤t₂) from the current time.

FIG. 6 is a diagram showing an example of the yaw rate profile in which the yaw rate of the target 20 decreases. In an embodiment, the path generating device 100 may generate the yaw rate profile in which the yaw rate of the target 20 decreases and then remains constant when the current yaw rate γ_{tgt,0} of the target 20 is greater than or equal to a predetermined value.

In FIG. 6, t1 represents time when the yaw rate of the target 20 becomes 0. The yaw rate of the target 20 decreases until time t₁ and then becomes 0 from time t₁. The decrease gradient of t₁ or yaw rate may be fixed or adjusted depending on the driving conditions.

FIG. 7 is a diagram showing an example of the yaw rate profile in which the yaw rate of the target 20 decreases. In an embodiment, the path generating device 100 may generate the yaw rate profile in which the yaw rate of the target 20 decreases in the form of a step function when the current yaw rate γ_{tgt,0} of the target 20 is less than a predetermined value.

In FIG. 7, t₁ represents time when the yaw rate of the target 20 is kept constant at the initial yaw rate value γ_{tgt,0} and then becomes 0. The yaw rate of the target 20 becomes 0 from time t₁. t₁ may be fixed or adjusted depending on the driving conditions.

Meanwhile, the yaw rate profile of the target 20 is not limited to the examples shown in FIG. 6 and FIG. 7, and various types of yaw rate profiles may be generated depending on the driving conditions.

The path generating device 100 predicts, in step S250, the path of the target 20 based on the yaw rate profile of the target 20 calculated in step S240. The path generating device 100 may use the yaw rate profile of the target 20 calculated in step S240, during kinematics-based path prediction or lane-related path prediction.

In the present disclosure, the predicted path of the target 20 may be expressed as a point set, which is a sequence of points that include the position information and direction information of the target 20 at each time. The size of the point set (the number of elements in the point set) is determined based on the length of the prediction time window and the length of the prediction time interval. For example, if the length of the prediction time window is 4 seconds and the length of the prediction time interval is 0.1 seconds, the point set contains 41 points (=4s/0.1s+1). Each point (element) included in the point set represents the target's position and direction information at each time. For example, each point may be represented as X_{tgt,t}, γ_{tgt,t}, and θ_{tgt,t}. Here, X_{tgt,t} and γ_{tgt,t} are the target positions at time t seconds later in the ego coordinate at the current time, and θ_{tgt,t} is the target heading angle at time t seconds later in the ego coordinate at the current time.

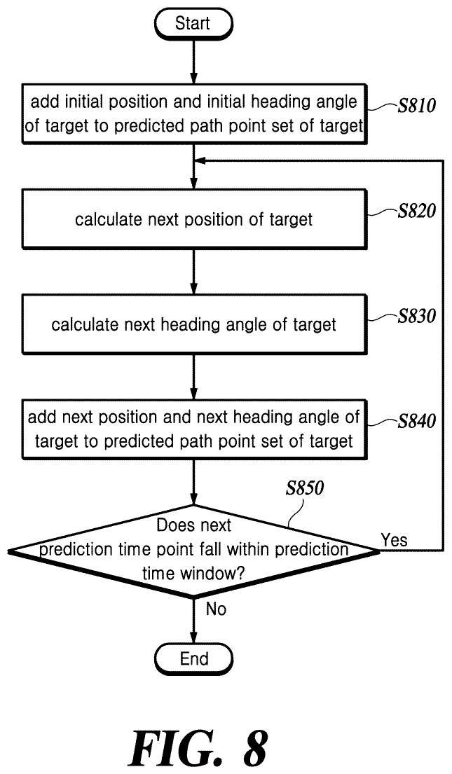

FIG. 8 is a flowchart illustrating a process in which the path generating device 100 according to an embodiment of the present disclosure performs kinematics-based path prediction on the target 20 based on the yaw rate profile, speed profile, and current position of the target 20.

The path generating device 100 adds a point representing the initial position X_{tgt,0}, γ_{tgt,0} of the target 20 received from one or more sensors attached to the ego vehicle 10 and the initial heading angle θ_{tgt,0} to the predicted path point set of the target 20, in step S810.

The path generating device 100 calculates the position of the target 20 at a next time based on the position, heading angle, and speed profile of the target 20 at the previous time, in step S820. Equation 10 is an equation for calculating a next position of the target 20.

$$\{ \begin{matrix}{X}_{tgt , t} = {X}_{tgt , t - 1} + \vert {V}_{tgt , t - 1} \vert \cdot Δ t \cdot cos {θ}_{tgt , t - 1} \\ {Y}_{tgt , t} = {Y}_{tgt , t - 1} + \vert {V}_{tgt , t - 1} \vert \cdot Δ t \cdot sin {θ}_{tgt , t - 1}\end{matrix} \qquad [ Equation 10 ]$$

In Equation 10, X_{tgt,t}, γ_{tgt,t} represent the position of the target 20 at time t, |V_{tgt,t}| represents the speed of the target 20 at time t, θ_{tgt,t} represents the heading angle of the target 20 at time t, and Δt is the size of the prediction time interval.

The path generating device 100 calculates the heading angle of the target 20 at the next time based on the heading angle and yaw rate profile of the target 20 at the previous time, in step S830. Equation 11 is an equation for calculating a next heading angle of the target 20.

$${θ}_{tgt , t} = {θ}_{tgt , t - 1} + {γ}_{tgt , t - 1} \cdot Δ t \qquad [ Equation 11 ]$$

In Equation 11, θ_{tgt,t} represents the heading angle of the target 20 at time t, γ_{tgt,t} represents the yaw rate of the target 20 at time t, and Δt represents the size of the prediction time interval.

The path generating device 100 adds a point representing the updated position X_{tgt,t}, γ_{tgt,t} and updated heading angle θ_{tgt,t} of the target 20 to the predicted path point set of the target 20, in step S840.

The path generating device 100 determines whether a next prediction time t+1 is included in the prediction time window, in step S850. If the next prediction time t+1 is included in the prediction time window (S850—YES), the path generating device 100 repeats steps S820 to S840 for the next prediction time. If the next prediction time t+1 is not included in the prediction time window (S850—NO), the path generating device 100 terminates the path prediction process for the target 20.

In the past, when the ego vehicle and the target are turning (e.g., roundabouts, high-curvature ramps) in a situation where map information and lane information are not available (e.g., past map information, rainy conditions where a sensor has difficulty in recognizing a lane, etc.), the target's path is predicted to be a straight path by assuming the target's yaw rate to be 0. On the other hand, as described with reference to FIG. 8, the method according to the present disclosure may perform the kinematics-based path prediction using the ground yaw rate profile of the target, thereby enabling the target's turning movement to be predicted with high accuracy even in a situation where map information and lane information are unavailable.

The path generating device 100 may use the yaw rate profile of the target 20 calculated in step S240, when performing the lane-related path prediction, i.e., path prediction for the target driving in relation to the lane.

The lane-related path prediction is performed on an S-N coordinate, where an S-axis represents the length of the lane (the tangential length) and an N-axis represents a normal distance from the lane.

The path generating device 100 converts the current speed of the target 20 in the ego coordinate into the current speed of the target 20 in the S-N coordinate using a lane's travel direction θₗᵢₙₑ to generate a longitudinal speed profile and a lateral speed profile of the target 20 in the S-N coordinate.

The path generating device 100 should determine an angular difference between the initial heading angle of the target and the travel direction of the lane for conversion between the ego coordinate and the S-N coordinate. The path generating device 100 may correct the angular difference between the initial heading angle of the target and the travel direction of the lane, by using the yaw rate profile of the target 20 calculated in step S240.

Equation 12 is an equation for calculating the angular difference between the initial heading angle of the target and the travel direction of the lane.

$${θ}_{Lane}^{′} = {θ}_{Lane} - {\int }_{0}^{T} {γ}_{tgt , t} \cdot dt \qquad [ Equation 12 ]$$

In Equation 12, θ_{Lane} represents the angular difference between the initial heading angle of the target and the travel direction of the lane, and θ_{Lane} represents the travel direction of the lane. γ_{tgt,t} represents the yaw rate of the target at time t, and T is a tuning parameter reflecting a correction degree.

Equation 13 is an equation for converting the target's speed from the ego coordinate to the S-N coordinate using θ′_{Lane} calculated according to Equation 12.

$$\{ \begin{matrix}{V}_{S , tgt , 0} = {V}_{x , tgt , 0} cos ( {θ}_{Lane}^{′} ) + {V}_{y , tgt , 0} sin ( {θ}_{Lane}^{′} ) \\ {V}_{N , tgt , 0} = {V}_{y , tgt , 0} cos ( {θ}_{Lane}^{′} ) - {V}_{x , tgt , 0} sin ( {θ}_{Lane}^{′} )\end{matrix} \qquad [ Equation 13 ]$$

In Equation 13, (V_{x,tgt,0}, V_{y,tgt,0}) represents the initial speed of the target 20 in the ego coordinate, and (V_{S,tgt,0}, V_{N,tgt,0}) represents the initial speed of the target 20 in the S-N coordinate.

Conventionally, it is difficult to predict the target's path when the target suddenly changes its driving direction due to the signal delay of the sensor. For example, it is difficult to predict the target's path in a scenario where the target abruptly cuts in the driving lane of the ego vehicle or in a scenario where the target turns on the ramp and simultaneously cuts out of the driving lane of the ego vehicle.

On the other hand, the method according to the present disclosure corrects the travel direction of the lane using the ground yaw rate profile of the target during the lane-related path prediction, thereby overcoming errors caused by signal delay of the sensor and enabling the path of the target to be predicted with high accuracy by reflecting abrupt direction changes of the target.

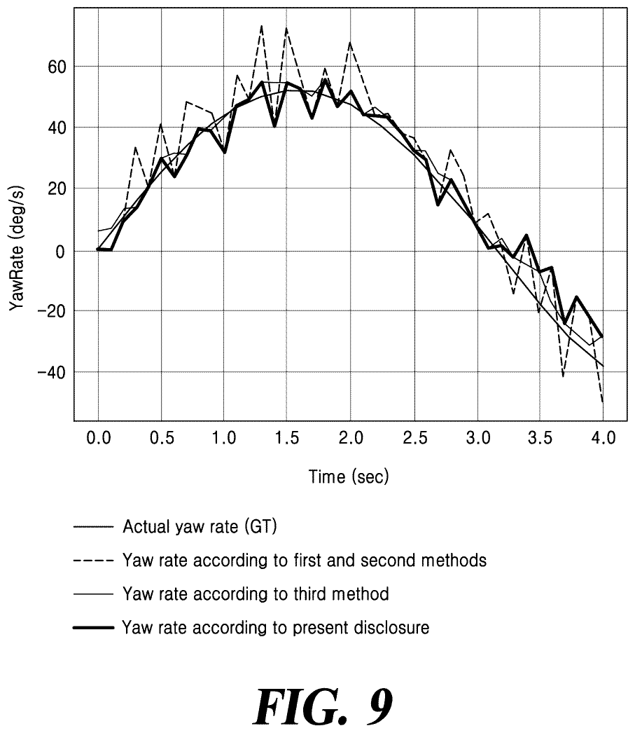

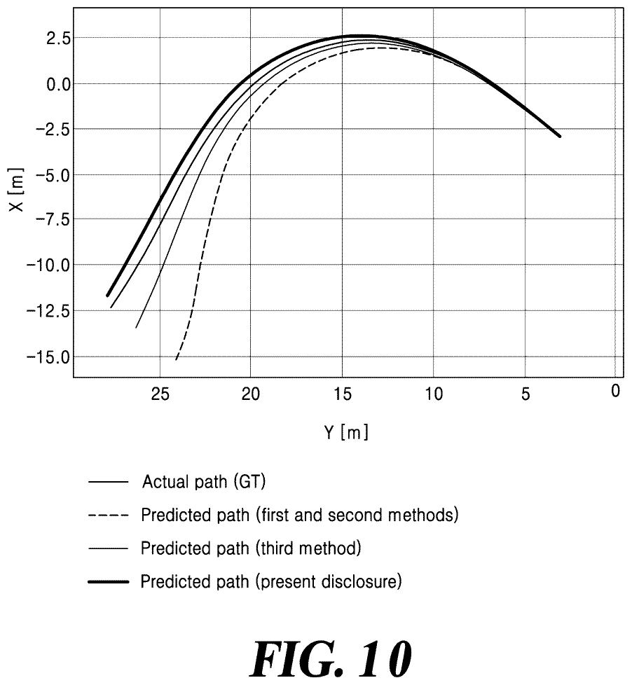

FIG. 9 and FIG. 10 are diagrams illustrating an example of experimental results comparing the yaw rate value and predicted path calculated according to an embodiment of the present disclosure with the actual yaw rate value and driving path of the target.

FIG. 9 is a graph comparing yaw rate values of the target for each time calculated through various methods with actual yaw rate values of the target for each time. In FIG. 9, the red line represents the actual yaw rate values of the target for each time in the prediction time window, the green dotted line represents the yaw rate values of the target calculated according to the first and second methods, the black dotted line represents the yaw rate values of the target calculated according to the third method, and the blue line represents the yaw rate values of the target calculated according to the present disclosure.

Referring to FIG. 9, it can be seen that the yaw rate values calculated according to the present disclosure have a smaller fluctuation range compared to the yaw rate values according to the first and second methods. From this, it can be seen that the yaw rate can be estimated more robustly by using the yaw rate estimation method according to the present disclosure.

Further, referring to FIG. 9, it can be seen that the yaw rate values according to the first, second, and third methods are generally calculated to be higher than the actual yaw rate values. On the other hand, it can be seen that the yaw rate values calculated according to the present disclosure cross above and below the curve representing the actual yaw rate values and have values similar to the actual yaw rate on average. From this, it can be seen that the yaw rate can be estimated more accurately by using the yaw rate estimation method according to the present disclosure.

FIG. 10 is a graph comparing the predicted paths of the target calculated through various methods with the actual driving path of the target. In FIG. 10, the red line represents the actual driving path of the target in the prediction time window, the green dotted line represents the predicted path of the target based on the first and second methods, the black dotted line represents the predicted path of the target based on the third method, and the blue line represents the predicted path of the target based on the method according to the present disclosure.

Referring to FIG. 10, it can be seen that the predicted path based on the method according to the present disclosure among the predicted paths of the target is most similar to the actual driving path of the target. From this, it can be seen that the target path prediction accuracy is improved when predicting the target path using the yaw rate estimation value based on multiple different yaw rate estimation methods.

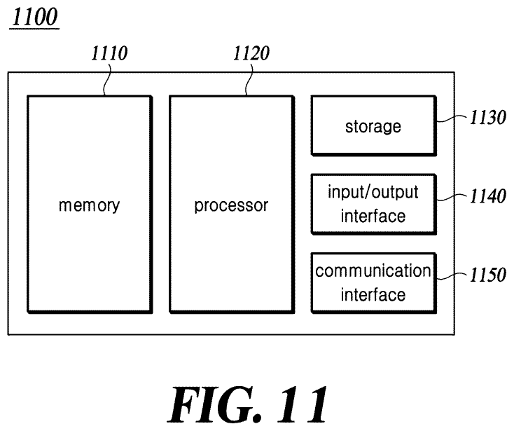

FIG. 11 is a block diagram schematically illustrating a computing device that may be used to implement a method or apparatus according to the present disclosure.

The computing device 1100 may include some or all of a memory 1110, a processor 1120, a storage 1130, an input/output interface 1140, and a communication interface 1150. The computing device 1100 may structurally and/or functionally include at least a portion of the apparatus according to the present disclosure. The computing device 1100 may be a stationary computing device such as a desktop computer or a server as well as a mobile computing device such as a laptop computer, a smart phone, or a vehicle electronic component. The computing device 1100 may be implemented as any specialized hardware accelerator capable of processing operations for an artificial intelligence model in an efficient manner. For example, the computing device 1100 may include a graphic processing unit (GPU), a tensor processing unit (TPU), or a neural processing unit (NPU).

The memory 1110 may store a program that causes the processor 1120 to perform methods or operations according to various embodiments of the present disclosure. For example, the program may include a plurality of instructions executable by the processor 1120, and the above-described method or operations may be performed by executing the plurality of instructions through the processor 1120. The memory 1110 may be a single memory or multiple memories. In this case, information required to perform the method or operation according to various embodiments of the present disclosure may be stored in the single memory or divided and stored in the multiple memories. When the memory 1110 comprises multiple memories, the multiple memories may be physically separated. The memory 1110 may include at least one of volatile memory or non-volatile memory. The volatile memory includes SRAM (Static Random Access Memory) or DRAM (Dynamic Random Access Memory), and the nonvolatile memory includes flash memory.

The processor 1120 may include at least one core capable of executing at least one instruction. The processor 1120 may execute instructions stored in the memory 1110. The processor 1120 may be a single processor or multiple processors.

The storage 1130 maintains stored data even when power supplied to the computing device 1100 is cut off. For example, the storage 1130 may include the non-volatile memory and may include storage media such as magnetic tape, optical disks, or magnetic disks. A program stored in the storage 1130 may be loaded into the memory 1110 before being executed by the processor 1120. The storage 1130 may store a file written in a programming language, and a program generated from the file by a compiler or the like may be loaded into the memory 1110. The storage 1130 may store data to be processed by the processor 1120 and/or data processed by the processor 1120.

The input/output interface 1140 may provide an interface with an input device such as a keyboard or a mouse, and/or an output device such as a display device or a printer. A user may trigger execution of a program by the processor 1120 through the input device and/or check the processing result of the processor 1120 through the output device.

The communication interface 1150 may provide access to an external network. The computing device 1100 may communicate with other devices through the communication interface 1150.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The e-readable recording medium may include all types of storage devices on which computer-readable data can be stored. The computer-readable recording medium may be a non-volatile or non-transitory medium, such as a read-only memory (ROM), a random access memory (RAM), a compact disc ROM (CD-ROM), magnetic tape, a floppy disk, or an optical data storage device. In addition, the computer-readable recording medium may further include a transitory medium, such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely a description of the technical idea of the present disclosure. In other words, those having ordinary skill in the art to which the present disclosure belongs may appreciate that various modifications and changes can be made without departing from essential features of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present disclosure is not limited by the illustrations. Accordingly, those of ordinary skill in the art should understand that the scope of the present disclosure should not be limited by the above explicitly described embodiments but by the claims and equivalents thereof.

What is claimed is:

1. A method for predicting a driving path of a target, the method comprising:
receiving driving information of an ego vehicle and the target from a plurality of sensors attached to the ego vehicle;
calculating a heading angle and driving direction of the target based on bounding box of the target, wherein the heading angle of the target is a heading angle of the bounding box of the target;
calculating a yaw rate of the target based on the heading angle and the driving direction of the target;
generating a yaw rate profile of the target based on the yaw rate of the target; and
predicting a path of the target based on the yaw rate profile of the target.

2. The method of claim 1, wherein calculating the yaw rate of the target comprises:
calculating a first yaw rate value based on an amount of change in the heading angle of the target;
calculating a second yaw rate value based on an amount of change in the driving direction of the target;
calculating a third yaw rate value based on a difference between the heading angle and driving direction of the target; and
calculating the yaw rate of the target based on the first yaw rate value, the second yaw rate value, and the third yaw rate value.

3. The method of claim 2, wherein a tracking time of at least one of the plurality of sensors for the target is longer than a predetermined time length for calculating the first yaw rate value, the second yaw rate value, and the third yaw rate value.

4. The method of claim 2, wherein each of a change amount of the heading angle, a change amount of the driving direction, and the difference between the heading angle and the driving direction is less than a predetermined value to prevent the first yaw rate value, the second yaw rate value, and the third yaw rate value from diverging.

5. The method of claim 2, wherein each of a change amount of the heading angle, a change amount of the driving direction, and the difference between the heading angle and the driving direction is a denoising filtered value, and
wherein a denoising filtering is low-pass filtering or moving average filtering.

6. The method of claim 2, wherein the difference between the heading angle and driving direction of the target is a difference between a driving direction of the target at current time and a heading angle of the target at past time before a predetermined time.

7. The method of claim 2, wherein the yaw rate of the target is a yaw rate with a minimum absolute value from the first yaw rate value, the second yaw rate value, and the third yaw rate value.

8. The method of claim 2, wherein signs of the first yaw rate value, the second yaw rate value, and the third yaw rate value are same with each other.

9. The method of claim 2, wherein the plurality of sensors comprises different types of sensors, and
wherein the target is recognized by two or more different types of sensors from the plurality of sensors.

10. The method of claim 2, wherein a speed of the target is greater than a first predetermined speed.

11. The method of claim 2, wherein a speed of the target is less than a second predetermined speed.

12. The method of claim 2, wherein the difference between the heading angle and the driving direction of the target is within a predetermined range.

13. The method of claim 1, wherein generating the yaw rate profile of the target comprises generating a sequence of yaw rate values representing yaw rate values in a prediction time window of the target,
wherein the yaw rate values are sequentially decreased based on the yaw rate of the target being equal to or greater than a predetermined value, and
wherein the yaw rate values are decreased in a form of a step function when the yaw rate of the target is less than the predetermined value.

14. The method of claim 1, wherein predicting the path of the target comprises:
(a) adding a point representing a position and heading angle of the target at current time to a path prediction point set of the target;
(b) calculating a position of the target at next time point based on a previous point and speed profile of the target;
(c) calculating a heading angle of the target at next time point based on the yaw rate profile of the target;
(d) adding a point representing the position and the heading angle of the target at the next time point to the path prediction point set of the target; and
(e) repeating the steps (b), (c) and (d) for each of time points included in a prediction time window of the target.

15. The method of claim 1, wherein the target is lane-related driving,
wherein predicting the path of the target comprises:
receiving at least one of lane information and map information; and
calculating speed of the target in an S-N coordinate based on the yaw rate profile of the target.

16. An apparatus for predicting a driving path of a target, the apparatus comprising:
at least one memory configured to store commands; and
at least one processor, by executing the commands, to:
receive driving information of an ego vehicle and the target from a plurality of sensors attached to the ego vehicle;
calculate a heading angle and driving direction of the target based on bounding box of the target, wherein the heading angle of the target is a heading angle of the bounding box of the target;
calculate a yaw rate of the target based on the heading angle and the driving direction of the target;
generate a yaw rate profile of the target based on the yaw rate of the target; and
predict a path of the target based on the yaw rate profile of the target.
